(19) United States
(12) Patent Application Publication
(10) Pub. No.: US 2004/0012954 A1
(43) Pub. Date: Jan. 22, 2004

(54) Wearable light including intermittent switch

(76) Inventor: Donald Timothy Hart, San Antonio, TX (US)

Correspondence Address: LAW OFFICES OF CHRISTOPHER L. MAKAY, 1634 Milam Building, 115 East Travis Street, San Antonio, TX, 78205, US

(21) Appl. No.: 10/196,540

(22) Filed: Jul. 16, 2002

(51) Int. Cl. F21V 21/08; G08B 5/36

(52) U.S. Cl. 362/191; 362/103; 362/276; 340/321; 340/331

(57) ABSTRACT

A light includes a case, a light source, and circuitry supported by the case. The circuitry is adapted to intermittently supply power to the light source.

### BACKGROUND OF THE INVENTION

1. Field of the Invention

The present invention relates to lights and, more particularly, but not by way of limitation, to a light wearable by a user and intermittently operable to draw attention to the user.

2. Description of the Related Art

Exercise in the form of walking, jogging, cycling, and the like, has become prevalent in today's health conscious society. Further, bike riding is a favorite past time of children. While participating in these activities is important for health as well as fun for children, such participation does present a certain amount of danger to the participant. Particularly, there are often inadequate trails and sidewalks, which forces participants into streets where they are exposed to motor vehicle traffic. As a result, each year many persons including children are struck by motor vehicles, causing injury and sometimes death. Accordingly, improving the ability of motor vehicle operators to see walkers, joggers, and cyclists, particularly children, is extremely important.

### SUMMARY OF THE INVENTION

In accordance with the present invention, a light includes a case, a light source, and circuitry supported by the case and adapted to supply power to the light source. The circuitry intermittently operates the light source and, in particular, intermittently operates the light source responsive to movement of the light.

The circuitry includes an intermittent switch that opens and closes responsive to movement of the light to permit intermittent supply of power to the light source. The circuitry further includes a positive terminal that electrically connects the light source to a battery of the circuitry. The positive terminal also secures the light source to the case. The circuitry still further includes a negative terminal and an on/off switch.

The light further includes a strap that permits attachment of the light to a user. With the light attached to the user, the circuitry intermittently operates the light source responsive to movement of the user.

A method of signaling includes providing a light that operates intermittently responsive to motion, attaching the light to a user, and moving such that the light operates intermittently.

It is therefore an object of the present invention to provide a light operated intermittently so that a signal easily detectable by a motor vehicle operator is produced.

It is a further object of the present invention to provide a light operated intermittently responsive to the movement of a user so as to diminish the possibility of the user being struck by a motor vehicle.

Still other objects, features, and advantages of the present invention will become evident to those of ordinary skill in the art in light of the following.

### BRIEF DESCRIPTION OF THE DRAWINGS

FIG. 1 is a perspective view illustrating a first embodiment of a wearable light including intermittent switch.

FIG. 2 is a top plan view in partial cross-section illustrating the first embodiment of the wearable light including intermittent switch.

FIG. 3 is a perspective view illustrating a second embodiment of a wearable light including intermittent switch.

### DETAILED DESCRIPTION OF THE PREFERRED EMBODIMENTS

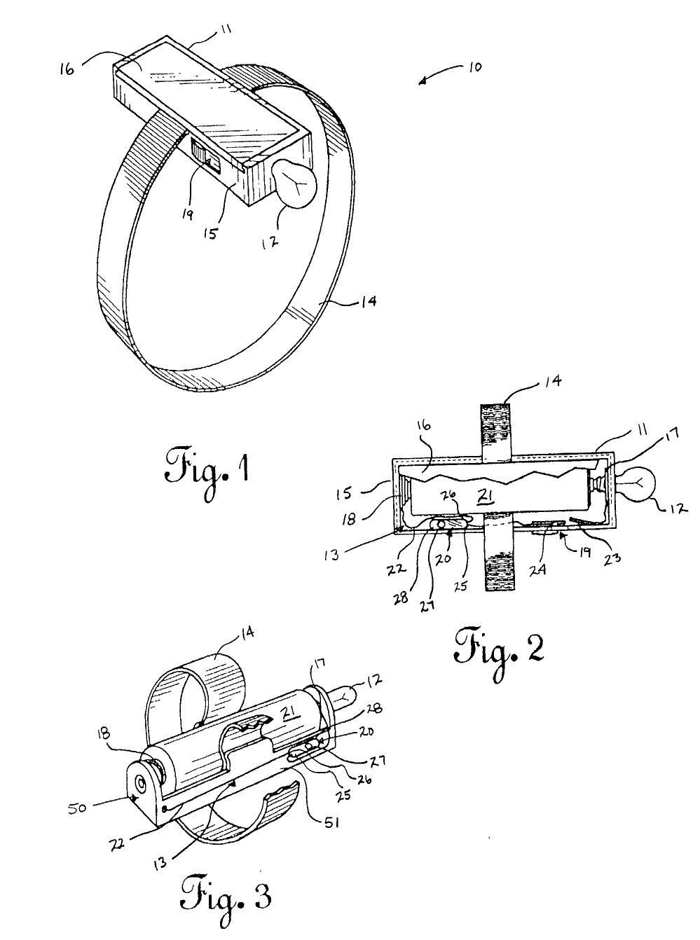

As illustrated in FIGS. 1 and 2, a light 10 includes a case 11, a light source 12, circuitry 13, and a strap 14. The case 11 includes a housing 15 and a lid 16. The housing 15 provides an enclosure for the circuitry 13. The housing 15 includes a groove and the lid 16 includes a lip whereby the lip of the lid 16 engages the groove of the housing 15 to facilitate attachment of the lid 16 to the housing 15. Although this first embodiment discloses attaching the lid 16 to the housing 15 via a lip and groove, those of ordinary skill in the art will recognize many alternative attachment means, such as a hinge.

The light source 12 provides a visual signal and in this first embodiment is a light bulb. Nevertheless, those of ordinary skill in the art will recognize many alternative light sources, such as an LED.

The circuitry 13 supplies power to the light source 12 and includes a positive terminal 17, a negative terminal 18, an on/off switch 19, an intermittent switch 20, a battery 21, and wiring 22 that couples together the positive terminal 17, the negative terminal 18, the on/off switch 19, and the intermittent switch 20. The positive terminal 17 attaches to the housing 15 using any suitable means, such as a clip, an adhesive, spot welding, sonic welding, or integral attachment therewith during the formation of the housing 15. Similarly, the negative terminal 18 attaches to the housing 15 using any suitable means, such as a clip, an adhesive, spot welding, sonic welding, or integral attachment therewith during the formation of the housing 15.

The housing 15 and the positive terminal 17 both include apertures that receive the light source 12 therethrough to secure the light source 12 to the positive terminal 17 and permit engagement of the light source 12 with the positive terminal of the battery 21. In this first embodiment the positive terminal 17 is a plate that secures the light source 12 while the light source 12 directly engages the positive terminal of the battery 21. Nevertheless, those of ordinary skill in the art will recognize many alternative apparatus and methods of coupling the light source 12 with the battery 21. Illustratively, the positive terminal 17 could be a socket that directly engages the positive terminal of the battery 21 and is adapted to receive the light source 12 therein.

The on/off switch 19 includes a first contact 23 and a second contact 24. The first contact 23 mounts within the housing 15 using any suitable means, such as a clip, an adhesive, spot welding, sonic welding, or integral attachment therewith during the formation of the housing 15. The second contact 24 includes a trigger attached to a plate with a space therebetween. The plate fits through an opening in the housing 15 and resides within the housing 15 while the trigger remains exterior to the housing 15. A portion of the housing 15 resides within the space to ensure the second contact 24 remains secured to the housing 15. In an off position of the on/off switch 19, the second contact 24 is disengaged from the first contact 23, however, sliding the second contact 24 forward using the trigger moves the second contact 24 such that it engages the first contact 23, thereby placing the on/off switch 19 in an on position. Conversely, sliding the second contact 24 rearward using the trigger moves the second contact 24 such that it disengages the first contact 23, thereby returning the on/off switch 19 to its off position. Although this first embodiment discloses the on/off switch as a sliding switch, those of ordinary skill in the art will recognize many alternative switches, such as a push button switch.

The intermittent switch 20 includes a first contact 25, a second contact 26, a drop 27 of a heavy metal such as mercury, and an enclosure 28. The enclosure 28 mounts in the housing 15 using any suitable means, such as a bracket, a clip, an adhesive, or the like. The first contact 25 and the second contact 26 reside within the enclosure 28 at one end. The drop 27 moves freely within the enclosure 28 and responds to motion to intermittently engage and disengage the first contact 25 and the second contact 26. When the drop 27 moves off the first contact 25 and the second contact 26, the first contact 25 and the second contact 26 are open so that the light source 12 is off. However, when the drop 27 moves onto the first contact 25 and the second contact 26, the first contact 25 and the second contact 26 are closed so that the light source 12 is on. Although this first embodiment discloses the intermittent switch 20 is a well-known mercury switch, those of ordinary skill in the art will recognize that any switch capable of intermittent operation may be substituted. Furthermore, the intermittent switch 20 of the first embodiment could be substituted with an integrated circuit that produces a timing signal that strobes the light source 12.

The strap 14 fits around a user, primarily an arm or a leg, to secure the light 10 to the user. In this preferred embodiment, the strap 14 is an elastic band, however, those of ordinary skill in the art will recognize many suitable materials and means to permit attachment of the light 10 to a user. In addition, it is contemplated that the light 10 may include attachment means suitable to permit the securing of the light 10 to a cycle.

In operation, a user fits the strap 14 around an extremity and places the on/off switch to its on position. The user then merely performs the desired activity of walking, jogging, or cycling. As the user moves in performing the desired activity, that movement constantly shifts the drop 27 within the enclosure 28 of the intermittent switch 20 on an off the first contact 25 and the second contact 26. Consequently, the light source 12 continuously strobes on and off, thereby providing a light signal easily detectable by motor vehicle operators to thus diminish the possibility of the user being struck by a motor vehicle.

As illustrated in FIG. 3, a second embodiment of a light 50 is identical to the first embodiment of the light 10, except the on/off switch 19 has been removed from the circuitry 13 and a case 51 has been substituted for the case 11. The case 51 in the second embodiment does not fully enclose the circuitry 13 and actually supports the intermittent switch 20 on its exterior. Removal of the battery 21 turns off the light 50. The light 50 nevertheless operates identically to the light 10; consequently, remaining like parts have been labeled with like numerals.

Although the present invention has been described in terms of the foregoing embodiments, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing description; rather, it is defined only by the claims that follow.

I claim:

1. A light, comprising:
a case;
a light source; and
circuitry supported by the case and adapted to supply power to the light source, whereby the circuitry intermittently operates the light source.

2. The light according to claim 1, wherein the circuitry intermittently operates the light source responsive to movement of the light.

3. The light according to claim 1, wherein the circuitry comprises an intermittent switch that opens and closes responsive to movement of the light to permit intermittent supply of power to the light source.

4. The light according to claim 3, wherein the circuitry comprises a positive terminal that electrically connects the light source to a battery of the circuitry.

5. The light according to claim 3, wherein the positive terminal secures the light source to the case.

6. The light according to claim 4, wherein the circuitry comprises a negative terminal.

7. The light according to claim 3, wherein the circuitry comprises an on/off switch.

8. The light according to claim 3, wherein the intermittent switch comprises a mercury switch.

9. The light according to claim 1, further comprising a strap that permits attachment of the light to a user.

10. A light, comprising:
a case;
a strap that permits attachment of the light to a user;
a light source; and
circuitry supported by the case and adapted to supply power to the light source, whereby the circuitry intermittently operates the light source responsive to movement of the user.

11. The light according to claim 10, wherein the circuitry comprises an intermittent switch that opens and closes responsive to movement of the user to permit intermittent supply of power to the light source.

12. The light according to claim 11, wherein the circuitry comprises a positive terminal that electrically connects the light source to a battery of the circuitry.

13. The light according to claim 11, wherein the positive terminal secures the light source to the case.

14. The light according to claim 12, wherein the circuitry comprises a negative terminal.

15. The light according to claim 11, wherein the circuitry comprises an on/off switch.

16. The light according to claim 11, wherein the intermittent switch comprises a mercury switch.

17. A method of signaling, comprising:
providing a light that operates intermittently responsive to motion;
attaching the light to a user; and
moving such that the light operates intermittently.
